(19) United States
(12) Patent Application Publication
(10) Pub. No.: US 2006/0272717 A1
(43) Pub. Date: Dec. 7, 2006

(54) Valve device for containing and preventing backflow of fluids

(76) Inventors: Rajat Agrawal, Naperville, IL (US); Gregory M. Jursich, Clarendon Hills, IL (US); John P. Borzio, Robbinsville, NJ (US); William F. Korzeniowski, Dayton, NJ (US); Donald W. Mitchell, Riegelsville, PA (US)

Correspondence Address: Linda K. Russell, Patent Counsel;Air Liquide, Suite 1800, 2700 Post Oak Blvd., Houston, TX, 77056, US

(21) Appl. No.: 11/412,117

(22) Filed: Apr. 27, 2006

Related U.S. Application Data
(60) Provisional application No. 60/686,343, filed on Jun. 1, 2005.
(60) Provisional application No. 60/761,505, filed on Jan. 24, 2006.

(51) Int. Cl. F16K 17/04

(52) U.S. Cl. 137/881

(57) ABSTRACT

A valve device that is securable to a cylinder includes a housing with a central passage in fluid communication with a first connection port that connects with a cylinder, and a second connection port including a passage that is in fluid communication with the central passage. The second connection port is configured to connect with a fluid flow line. A valve member is disposed within the second connection port and includes a movable member that engages with a seat to provide a fluid tight seal for the valve member in a closed position. The movable member is configured to be moved away from the seat so as to open the valve member and permit fluid to flow from the central passage of the valve housing around the movable member and through the second connection port while substantially preventing a backflow of fluids from a location external to the valve housing into the central passage.

### CROSS-REFERENCE TO RELATED APPLICATIONS

This application claims priority from U.S. Provisional Patent Application Ser. No. 60/686,343, entitled “Supply Containment System for Sub-atmospheric Gases and Low Vapor Pressure Liquids,” and filed Jun. 1, 2005, and from U.S. Provisional Patent Application Ser. No. 60/761,505, entitled “A Cylinder Device to Prevent Back-Flow,” and filed Jan. 24, 2006. The disclosures of these provisional patent applications are incorporated herein by reference in their entireties.

### BACKGROUND

1. Field

The disclosure pertains to valves that contain and control release of fluids from cylinders or containers to other parts of a system while preventing backflow of such fluids within the system.

2. Related Art

Many industries such as the semiconductor industry require the use of air-reactive gases such as metal hydrides (e.g., arsine, phosphine, silane, etc.) and corrosive gases (e.g., boron trifluoride, boron trichloride, tungsten hexafluoride, etc.). Examples of other air-reactive gaseous compounds include, without limitation, germanes, polysilanes such as trisilane, silyl-germanes, silylamines such as trisilylamine, and organometallic metal compounds.

In many semiconductor applications, process gases are typically supplied in storage cylinders at high pressure, with sufficient pressure reduction being maintained downstream of the cylinder to facilitate withdrawal of the gaseous product from the cylinder and delivery to a suitable location or tool for use in a system application. The downstream pressure is typically regulated using a pressure regulator or a similar device that is disposed in-line in the system and/or attached to the valve of the storage cylinder.

In recent years, because of safety concerns, alternate packaging methods known as the subatmospheric gas system (SAGS) have been developed to supply many of these gases. The term SAGS is defined as a system that includes a gas cylinder which under normal operation allows for a gas flow from a cylinder only when the cylinder valve outlet is exposed to a pressure of less than one atmosphere. By utilizing a SAGS system, gases are prevented from sudden escape of the cylinder and any inadvertent system leaks will not result in a rapid and excessive release of such gases to the surrounding environment.

In addition, certain new precursors are emerging for use in semiconductor and other manufacturing operations, where the precursors can be in the form of low vapor pressure liquids. Trisilane is an example which is a liquid with vapor pressure of 95.5 torr (12.73 kPa) at 0° C. Other examples include tetramethylsilane (4 MS), trisilamine (TSA), and octafluorocyclopentene (C5F8). Some of these new products are classified as pyrophoric. Typically, these products are stored in cylinders normally used for pressurized gases.

While the SAGS and low vapor pressure liquid systems minimize any uncontrolled release of dangerous compounds to the surrounding environment, they also present opportunities for back-diffusion of a contaminant (e.g., air) from outside during shipping, storage and/or usage of the gases or liquids. For example, if the storage cylinder valve is loose or opened by mistake, and/or if there is a leak anywhere else within the fluid line during system operation, ambient atmospheric components that are at greater pressure than the cylinder contents can enter into the cylinder. This in turn can result in explosive reactions for pyrophoric or flammable products, or to corrosion of valve and/or other cylinder components for corrosive gases. Conventional SAGS systems provide no safety mechanisms for preventing air infiltration and contamination due to back diffusion or flow into the cylinder.

Many applications using the types of sub-atmospheric gaseous or low vapor pressure liquid products in the semiconductor industry are also delivered in conjunction with other purge gases such as nitrogen for purging and cleaning the delivery lines before and after the delivery of the product. There always exists a possibility that the purge gas can diffuse back in the cylinder contaminating the product if one or more control valves are opened or closed by mistake.

In addition, even air reactive gases stored under higher pressures can experience air back diffusion during a particular application. For example, many semiconductor manufacturing operations are carried out under vacuum, such that the gaseous compound is withdrawn from a high pressure cylinder under vacuum even though it may be at a pressure higher than the ambient pressure. During a particular application in which the gas has been continuously withdrawn from a cylinder, the pressure within the cylinder can eventually drop below ambient pressure, which can then lead to potential back-diffusion of air within the cylinder if there is an inadvertent leak within the system or a cylinder valve is not closed properly or left open by mistake.

Thus, there are considerable safety and purity concerns associated with storing and using such air-reactive gases and liquid products without the assurance that backflow of fluids into the storage cylinder can be prevented.

### SUMMARY

A valve device, valve member and method are disclosed herein for delivering air-reactive and/or other compounds from a cylinder or supply source to a particular application while effectively preventing the possibility of any undesirable flow or diffusion of fluids back into the cylinder.

A valve device is provided that is securable to a cylinder and comprises a housing including a central passage in fluid communication with a first connection port that connects with a cylinder, and a second connection port including a passage that is in fluid communication with the central passage. The second connection port is configured to connect with a fluid flow line. A valve member is disposed within the second connection port and includes a movable member that engages with a seat to provide a fluid tight seal for the valve member in a closed position. The movable member is configured to be moved away from the seat so as to open the valve member and permit fluid to flow from the central passage of the valve housing around the movable member and through the second connection port while substantially preventing a backflow of fluids from a location external to the valve housing into the central passage.

In another embodiment, a valve member is provided comprising a hollow plug including a chamber, a first end and a second end, where the first and second ends include openings. A movable member is disposed within the chamber, and a biasing member is also provided, where the biasing member forces the movable member toward the first end of the plug so as to engage with a seat defined at the first end of the valve member. The movable member and seat engage to form a fluid tight seal to prevent fluids from entering the chamber via the first end opening, and the movable member is movable away from the seat to permit access of fluids through the chamber via the first end opening when the force applied by the biasing member is overcome by an opposing force applied to the movable member.

In a further embodiment, a method is provided for controlling fluid flow within a cylinder with a valve device secured to the cylinder. The method comprises securing a valve device to an outlet of the cylinder, where the valve device includes a valve housing with an outlet port to deliver fluid from the cylinder to a fluid flow line, and providing a valve member in the outlet port of the valve device. The valve member includes a passage that is in fluid communication with a central passage of the valve housing, and a movable member that engages with a seat to provide a fluid tight seal for the valve member in a closed position. The movable member is configured to be moved away from the seat so as to open the valve member and permit fluid to flow from the central passage of the valve housing around the movable member and through the outlet port while substantially preventing a backflow of fluids from a location external to the valve housing into the central passage.

The valve devices and corresponding methods are particularly useful for facilitating safe storage, shipping and/or delivery of gaseous and/or liquid fluids in cylinders at sub-atmospheric pressure conditions, such as air-reactive gases that are used in semiconductor manufacturing and processing applications, without the risk of backflow of fluids (e.g., air) into the cylinders. Thus, the valve devices and corresponding methods provide an effective solution to the problem of potential contamination and/or safety concerns associated with the storage and use of such fluids.

The above and still further features and advantages will become apparent upon consideration of the following detailed description of specific embodiments thereof, particularly when taken in conjunction with the accompanying drawings wherein like reference numerals in the figures are utilized to designate like components.

### BRIEF DESCRIPTION OF THE DRAWINGS

FIG. 1 is a schematic diagram of a valve device connected with a cylinder to prevent backflow of fluid into the cylinder.

FIG. 2 is a side view in partial cross-section of an exemplary embodiment of a valve device attached with a cylinder to prevent backflow of fluid into the cylinder.

FIGS. 3A and 3B are cross-sectional side views of an embodiment of a diaphragm valve that can be implemented for use with the valve device of FIG. 2, with a connector that opens the diaphragm valve to facilitate flow of fluid through the diaphragm valve.

FIGS. 4A and 4B are cross-sectional side views of another embodiment of a diaphragm valve that can be implemented for use with the valve device of FIG. 2, with a connector that opens the diaphragm valve to facilitate flow of fluid through the diaphragm valve.

FIG. 5 is a side view in partial cross-section of another exemplary embodiment of a valve device attached with a cylinder to prevent backflow of fluid into the cylinder.

FIGS. 6A and 6B are cross-sectional side views of a plug-type valve member that engages with a filling/outlet port of the valve device of FIG. 5 and prevents backflow of fluids into the outlet of the valve device during operation of the device.

FIGS. 7A and 7B are plots of temperature and pressure data measured within a cylinder that utilizes a valve device including the valve member of FIGS. 6A and 6B.

FIGS. 8A and 8B are cross-sectional side views of another embodiment of a plug-type valve member that engages with a filling/outlet port of a valve device and prevents backflow of fluids into the outlet of the valve device during operation of the device.

FIG. 9 is a plot of temperature and pressure data measured within a cylinder that utilizes a valve device including the valve member of FIGS. 8A and 8B.

### DETAILED DESCRIPTION

Valve devices are described herein that attach to a cylinder or other fluid supply source and effectively prevent backflow or diffusion of air and/or other fluids from system lines and/or the surrounding environment into the cylinder or fluid supply source. The valve devices can be used for semiconductor and/or other manufacturing processes or applications and can be used for storing, transporting and/or processing any suitable types of fluids. In particular, the valve devices are highly effective in preventing backflow into cylinders containing flammable, pyrophoric, corrosive and/or highly reactive gases stored at any selected pressures (e.g., for SAGS processes), where the compounds can be gaseous, liquid and/or solid and can include, without limitation, compounds such as germanes, methylsilanes, polysilanes such as trisilane, silyl-germanes, silylamines such as trisilylamine, organometallic metal compounds, boron trifluoride, boron trichloride, tungsten hexafluoride, fluorocarbons (e.g., octafluorocyclopentene or C₅F₈) and other organic or inorganic compounds (e.g., hexane, octane, etc.).

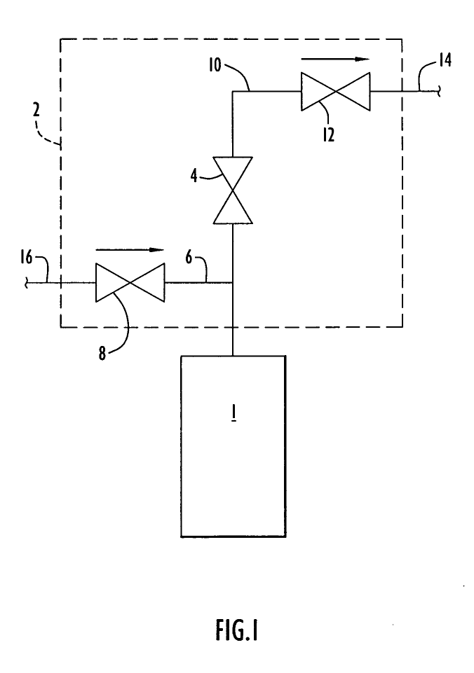

An exemplary valve device that can be connected with a cylinder is schematically depicted in FIG. 1. In particular, the valve device (which is shown generally as the dashed box 2) connects with a cylinder (shown generally as box 1) that stores a gas or liquid, such as any of the types described above. The valve device 2 can connect in any conventional or other suitable manner (e.g., via threaded engagement to cylinder 1) to achieve a fluid-tight seal. The valve device includes a main shut-off or stop valve 4 to open or close the valve device in order to permit flow of fluid from the cylinder to a processing site, a transfer line or filling port 6 including a valve 8 to facilitate filling of the cylinder with the fluid, and an outlet port 10 including a valve 12 to facilitate flow of fluid from the cylinder when shut-off valve 4 is opened. The filling and outlet ports connect in any conventional or other suitable manner (e.g., via a threaded engagement) with other fluid lines of the system to achieve a fluid tight seal.

Each of the valves in valve device 2 can be of any one or more suitable types including, without limitation, diaphragm valves, packed valves, bellows valves, ball valves, gate valves, butterfly valves, and globe valves, and these valves can be manipulated to open or closed positions manually (e.g., by an operator) and/or automatically (e.g., via pneumatic and/or electronic components). Valves 8 and 12 are preferably valves that facilitate the flow of fluid in one direction through the valves as described below.

In an exemplary embodiment, the valve device of FIG. 1 is used in combination with a cylinder that includes a low pressure gas (e.g., a gas at a subatmospheric pressure for use in a SAGS process) or a low vapor pressure liquid, where the pressure of the fluid within cylinder 1 is at a lower pressure than the surrounding environment and/or the pressure within a system line 14 that connects with outlet port 10. However, the valve device can also be used with a high pressure fluid in the same manner as with the low pressure fluid.

Valve 8 at filling port 6 facilitates the flow of fluid in one direction from a fluid transfer line 16 that connects with the filling port into cylinder 1 (as indicated by the arrow above valve 8 in FIG. 1), while preventing flow of fluid from the cylinder into line 16. Similarly, valve 12 facilitates the flow of fluid in one direction from the cylinder to system line 14 (as indicated by the arrow above valve 12 in FIG. 1), while preventing fluid flow from the system line back into the cylinder. Thus, the combination of valves in the valve device permit filling of the cylinder with fluid, delivery of fluid from the cylinder to an application, while preventing fluid backflows into the cylinder through valves 8 and 12, particularly when the pressure within the cylinder is lower than the surrounding pressure and/or the pressure within the system line or at a system location that is downstream from the cylinder.

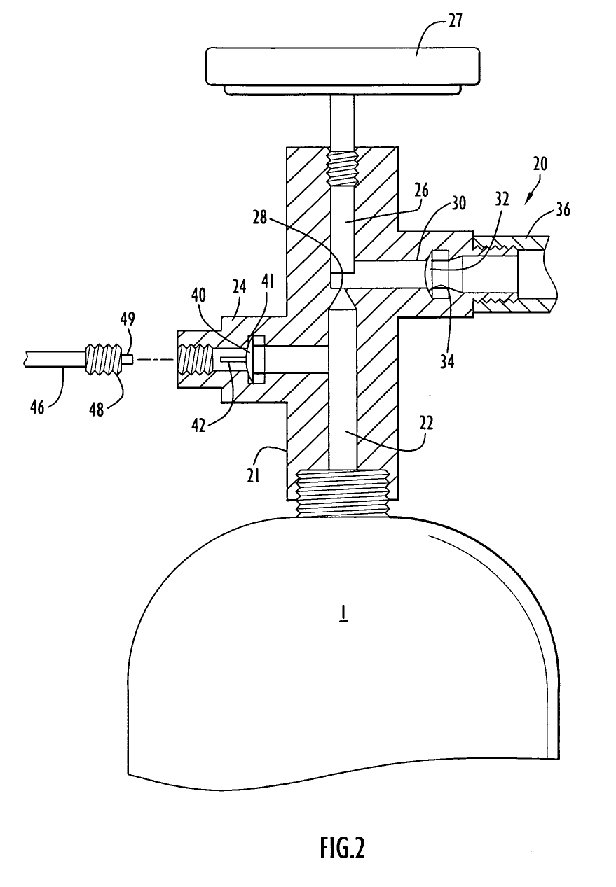

The schematic of the valve device set forth in FIG. 1 can be implemented in a number of different embodiments, where the different embodiments include different valves at the filling and/or outlet ports, where the different embodiments provide the same or similar operational features of the valve device. Referring to FIG. 2, an exemplary valve device 20 is depicted that operates in the manner as described above and schematically depicted in FIG. 1. The valve device 20 is connected to cylinder 1 via a threaded connection at a connection port 21 of the device. A main channel 22 extends axially within the main body 23 of the valve device and is in fluid communication with connection port 21 as well as a filling port 24 and an outlet port 30 which extend transversely from the main body.

A shut-off or stop valve is defined within the main body 23 by a movable body 26 that is axially movable within the main body to engage with a seat 28 located at an end of channel 22. The channel seat 28 provides a restricted channel passage to facilitate the formation of a fluid tight seal when movable body 26 engages with the seat. The movable body is further connected to a handle 27 that can be manipulated in a conventional or any other suitable manner to effect movement of the body 26 toward or away from seat 28 (e.g., by rotation of the handle and based upon a threaded engagement of the handle with the main body) in order to close or open the stop valve.

Outlet port 30 extends transversely from channel 22 at the location of the stop valve seat 28 such that, when movable body 26 is displaced or moved away from a sealing engagement with seat 28, the outlet port 30 is in fluid communication with channel 22 and cylinder 1. When the movable body engages with the seat, the stop valve is closed and prevents fluid flow between the cylinder and outlet port. The outlet port is also connectable (e.g., via a threaded connection) to a system fluid line 36 to which fluids from cylinder 1 are to be delivered.

A diaphragm valve 32 is disposed within the outlet port and engages with a narrowed portion or seat 34, which is located within the outlet port between the diaphragm and the stop valve seat 28, so as to form a fluid tight seal with seat 34. The diaphragm valve can be any conventional or other suitable type of diaphragm valve. For example, the diaphragm valve can include a diaphragm that is constructed of a thin and flexible sheet of rubber, plastic or metal material (e.g., stainless steel) and that is secured against the seat in any suitable manner (e.g., via fasteners, a resilient spring, etc.) to achieve the seal. The diaphragm is further movable or flexible to permit a selected degree of flexion or movement of one or more portions of the diaphragm away from the seat so as to release the fluid tight seal and thus open the valve when a threshold pressure differential is achieved in the desired direction across the diaphragm. The diaphragm further moves or flexes back to its original engaging position with the seat when the pressure differential is lower than the threshold value, thus resuming the fluid tight seal and closing the valve.

In the embodiment of FIG. 2, diaphragm valve 32 is configured such that the diaphragm slightly moves or flexes away from the seat and away from channel 22 so as to open the valve when the fluid pressure within cylinder 1 is greater than the pressure in fluid line 36. Preferably, the diaphragm valve 32 at outlet port 30 is configured such that a pressure differential across the diaphragm that is less than about 760 torr (101.3 kPa), where the pressure inside the cylinder is greater than the pressure inside the fluid line, enables opening of the valve. Most preferably, the pressure differential across the diaphragm that facilitates opening of the diaphragm valve at the outlet port is within the range of about 50 torr (6.67 kPa) to about 300 torr (40 kPa).

This valve configuration at the outlet port of the valve device is very useful, particularly in applications where a gaseous fluid or a low vapor pressure liquid is stored in the cylinder at very low pressures (e.g., SAGS applications), since the valve prevents fluids at higher pressures from flowing into the cylinder via the outlet port. Basically, diaphragm valve 32 ensures one way flow of fluid from cylinder 1 to process line 36 at all times during operation of the valve device.

Filling port 24 extends transversely from and is in fluid communication with channel 22 at a location between the connection port 21 and the stop valve seat 28. The filling port also includes a diaphragm valve 40 that is similar in configuration to the diaphragm valve disposed in the outlet port. In particular, the diaphragm valve includes a diaphragm (e.g., a thin sheet of rubber, plastic or metal) that is secured against a narrowed portion or seat 41, which is located within filling port 24 between the diaphragm and an inlet of the filling port, so as to form a fluid tight seal to close the valve. The diaphragm is further capable of flexing or moving away from the seat when a suitable force is applied against the diaphragm to move the diaphragm in a direction away from the seat and toward channel 22, such that the fluid tight seal is released to open the valve. Thus, the diaphragm valve is designed to prevent flow of fluid from the cylinder and through the filling port regardless of the fluid pressure within the cylinder. In addition, the diaphragm within the filling port is suitably secured against the seat to prevent fluids that are outside the cylinder (e.g., air), and which are at typical ambient and/or other system pressure levels, from forcing movement or flexure of the diaphragm so as to open valve 40.

Diaphragm valve 40 further includes a rod 42 that is secured to an outer end of the diaphragm and extends toward the inlet of filling port 24. A filling connector 46 connects with filling port 24 in any suitable manner (e.g., via a threaded engagement) to provide a fluid tight seal so as to facilitate filling of cylinder 1 through the filling connector with a fluid provided from a fluid supply source (e.g., another cylinder or a production facility, not shown). Secured at a suitable location within connector 46 is a threaded engaging member 48. The engaging member 48 includes an extension 49 that is configured to engage with rod 42 when the filling connector is securely fastened to the filling port. The contact between engaging member extension 49 and rod 42 forces flexure or movement of the diaphragm away from the seat, which opens diaphragm valve 40 to permit fluid flow through the valve and into the cylinder during filling of the cylinder. The filling connector and/or engaging member further include(s) one or more passages that permit flow of fluid through or around the engaging member during the cylinder filling operation.

In the embodiment of FIG. 2, the engaging member 48 is a male threaded member that provides the sealing connection with a corresponding female threaded portion of the filling port and serves to force extension 49 against rod 42 so as to push the rod rearwardly (i.e., toward channel 22), which in turn forces flexure or movement of the diaphragm rearwardly to open the valve. The male threaded engaging member 48 and extension 49 further include one or more channels extending from the terminal end of the extension to the fluid flow channel within filling connector 46. These channels are in fluid communication with the filling port when the filling connector is engaged with the filling port so as to facilitate fluid flow through the engaging member and into valve device 20. However, it is noted that the connector can also be designed with a female threaded connection and with a disk or other member disposed within the connector that engages with the rod of the diaphragm valve during assembly of the connector with the filling port.

In operation, cylinder 1 can be filled via filling port 24 of valve device 20 by connecting filling connector 46 with the filling port, which results in an opening of diaphragm valve 40 upon engagement of extension 49 with connector with rod 42 of the valve. The cylinder can be filled with fluid to a desired pressure, followed by removing the connector from the filling port which results in closing of valve 40. As noted above, the fluid pressure within cylinder 1 is incapable of opening valve 40 due to the design of the diaphragm within the valve device.

Upon connection of outlet port 30 of the valve device with system line 36, the stop valve can be opened by manipulation of handle 27 to effect movement of movable body 26 from valve seat 28. Opening of the stop valve facilitates fluid communication between main channel 22 and outlet port 30. As noted above, the diaphragm of diaphragm valve 32 flexes away from seat 34 only when the pressure is greater within the cylinder than the system line and when a suitable pressure differential is achieved. In operations in which the cylinder fluid is at very low pressures (e.g., SAGS operations), a vacuum is applied within fluid line 36 to facilitate movement or flexure of the diaphragm of valve 32 away from seat 34 in order to facilitate fluid flow from cylinder 1 into fluid line 36. Upon removal of the vacuum, the diaphragm flexes back to its original fluid tight engagement with seat 34, thus closing the diaphragm valve.

In the event the pressure level in the outlet port at a location downstream from diaphragm valve 32 becomes greater than the cylinder pressure level (e.g., in situations where a leak within the system line develops, or the stop valve is inadvertently left open or is defective and incapable of forming a seal with seat 28 during periods where the valve line is detached from the system line), the diaphragm remains in sealing contact with seat 34. Such a pressure differential across the diaphragm is further incapable of opening diaphragm valve 32, due to the valve design and configuration, which ensures the prevention of fluid backflow into the cylinder via the outlet port of the valve device.

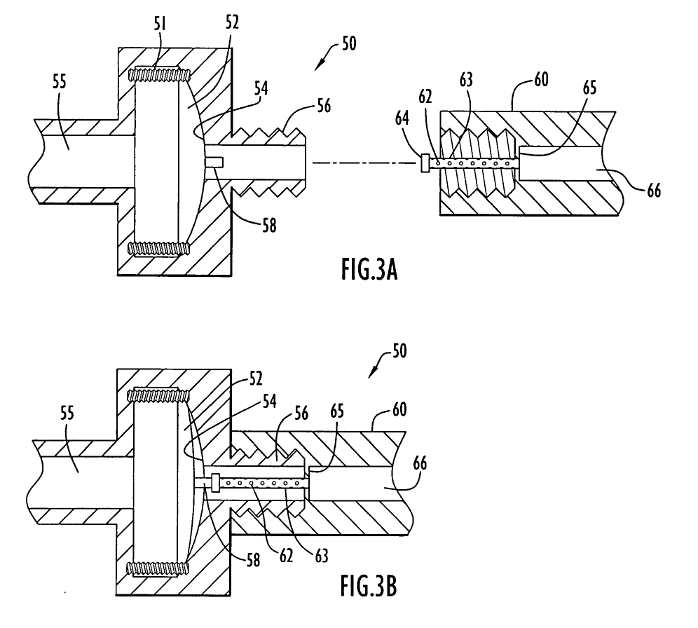

An alternative embodiment of a diaphragm valve that can be incorporated into a valve device is depicted in FIGS. 3A and 3B. This diaphragm valve can be incorporated, for example, within either or both of the outlet and filling ports of the valve device of FIG. 2. In addition, and as described in further detail below, this diaphragm valve can be incorporated into a valve device that has a single port to facilitate both filling of a cylinder and delivery of fluid from the cylinder to a process line.

Referring to FIG. 3A, diaphragm valve 50 includes a diaphragm 52 (e.g., a thin sheet of rubber, plastic or metal material, such as stainless steel or other steel alloys) that is secured within a valve housing (e.g., within the filling and/or outlet ports of the device of FIG. 2) and forced into engagement with a narrowed channel section or seat 54 disposed within the valve. The valve is designed such that diaphragm 52 is disposed between seat 54 and a channel or passage 55 that extends within the valve device. The diaphragm can be forced against the seat in any suitable manner (e.g., via threaded fasteners 51 as shown in FIGS. 3A and 3B or, alternatively, via resilient members such as springs or any other securing mechanism) so as to provide an effective fluid tight seal at the seat, while permitting movement or flexure of the diaphragm away from the seat (i.e., toward passage 55) when a suitable force or pressure is applied to the diaphragm. Upon removal of such force, the diaphragm is configured to resiliently move or flex back into its original engagement with the seat to close the valve.

Valve housing passage 55 extends from the diaphragm to a main passage of the valve device (e.g., passage 22 of the device of FIG. 2) that is in fluid communication with the cylinder to which the valve device is connected. In addition, the valve housing includes a connection member 56 with a passage that extends from valve seat 54 to an open end of the of the valve housing. The connection member 56 is configured to connect (e.g., via a threaded engagement) and form a fluid tight seal with a fluid line connection member 60. In the embodiment of FIGS. 3A and 3B, the valve housing connection member 56 includes a male threaded connection, while the fluid line connection member 60 includes a corresponding female threaded connection that facilitates connection of the two members. However, it is noted that this threaded connection can also be reversed. Alternatively, the connection can be of any other suitable type that provides a fluid tight seal at the connected members.

A pin or rod 58 is connected to an end of diaphragm 52 and extends a selected distance toward and/or within connection member 56. The fluid line connection member 60 includes a tubular member 62 that extends from a partition wall 65 within connection member 60 and through and/or slightly beyond the female threaded end of the connection member, where the outer diameter of the tubular member is smaller than the inner diameter of the connection member. Thus, an annular gap is defined between the tubular member and the internal female threaded wall portions of the fluid line connection member. The terminal end of member 62 includes a disk 64 that is configured to fit within valve housing connection member 56 and engage with rod 58 when the fluid line connection member is connected with the valve housing connection member. The other end of tubular member 62 that connects at wall 65 is in fluid communication with a fluid channel 66 defined on the other side of wall 65 and that leads to or defines a fluid line for a semiconductor manufacturing or other fluid processing system. Tubular member 62 also includes apertures or perforations 63 disposed longitudinally along the member and that extend through the wall thickness of the tubular member to permit fluid communication between the annular gap defined between the fluid line connector and tubular member and the hollow interior of the tubular member.

As can be seen in FIG. 3B, when the two corresponding connection members are secured to each other, tubular member 62 extends within valve housing connection member 56 such that disk 64 engages with rod 58 and forces diaphragm 52 to move or flex slightly away from valve seat 54 and toward passage 55. This results in an opening of the diaphragm valve to permit fluid to flow from the cylinder to which the valve device is attached, through passage 55 and around diaphragm 52, where the fluid then enters the interior of connection member 56. The fluid flows freely into tubular member 62 (via apertures 63) and then into fluid channel 66, where the fluid can then be directed to a desired process. When the connection members are disengaged from each other, tubular member 62 and disk 64 are removed from contact with diaphragm 52, which results in the diaphragm moving or flexing back to its original position against seat 54 so as to close the valve (as depicted in FIG. 3A).

The mechanical tension of the diaphragm against the valve seat of valve 50 can be configured to prevent flexion or movement of the diaphragm based upon a selected pressure differential between the cylinder pressure and the ambient pressure and/or pressure within the process line. In other words, the valve is designed to ensure the valve is only opened, under normal operating conditions, when fluid line connection member 60 is connected with valve connection member 56. In addition, the diaphragm can be designed to deform and open the valve at upper threshold pressures within the cylinder so as to prevent over-pressurization of the cylinder.

Thus, whether the fluid within the cylinder is maintained at sub-atmospheric conditions (e.g., for SAGS applications) or at higher pressures, the diaphragm valve can be configured to maintain an effective seal until it is mechanically moved during engagement between connectors 56 and 60. For example, in a SAGS application, a vacuum can be applied within fluid channel 66 once valve 50 is opened so as to withdraw sub-atmospheric fluids from the cylinder into the fluid channel. When the valve is closed (i.e., upon disconnecting member 60 from member 56), air from the ambient environment is prevented from infiltrating the cylinder at valve 50.

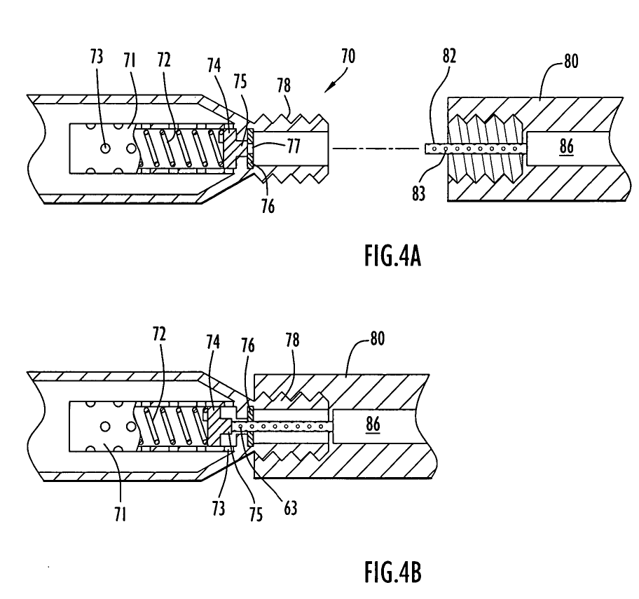

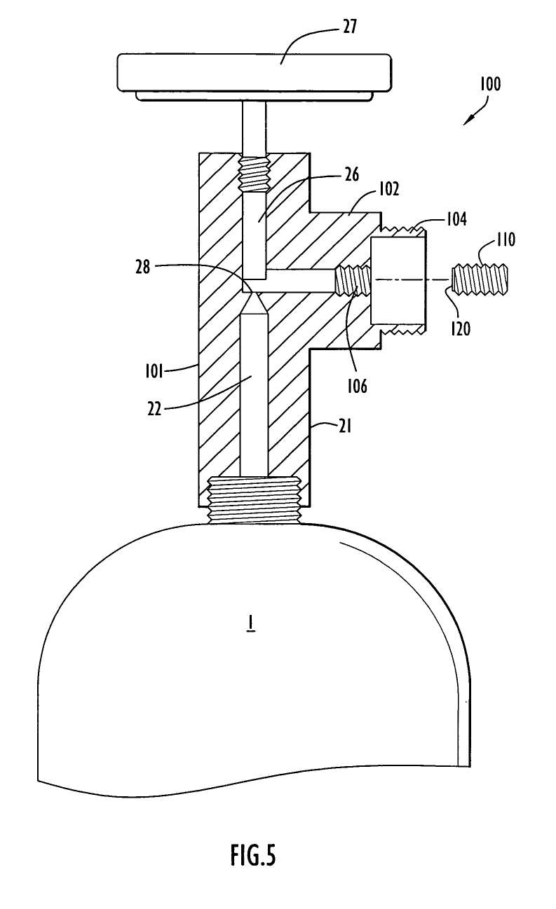

Another valve embodiment for use in a valve device (such as the device described in FIG. 2) is depicted in FIGS. 4A and 4B. As with the diaphragm valve depicted in FIGS. 3A and 3B, this valve can be incorporated, for example, within either or both of the outlet and filling ports of the valve device of FIG. 2. In addition, and as described in further detail below, this diaphragm valve can also be incorporated into a valve device that has a single port to facilitate both filling of a cylinder and delivery of fluid from the cylinder to a process line.

Valve 70 includes a hollow tubular member 71 secured within a channel of a valve housing (e.g., within the filling and/or outlet ports of the device of FIG. 2) and extending into a valve housing connection member 78. The connection member 78 forms an open end of the valve housing and includes a male threaded connection that is configured to connect and form a fluid tight seal with a fluid line connection member 80 that includes a corresponding female threaded connection. However, it is noted that the threaded connections for the connection members can be reversed or, alternatively, any other fluid tight fastener arrangement can also be implemented.

Tubular member 71 includes a coil spring 72 and a movable valve member 74 within the hollow interior of the tubular member. The coil spring 72 extends from a first closed end of the tubular member to bias movable valve member 74 toward a second open end of the tubular member, where the second open end is disposed within the connection member 78 proximate the open end of the valve housing. A plate 76 is secured at the second end of the tubular member and includes an orifice 77 that extends through the plate to provide a fluid flow passage from the hollow interior of tubular member 71 to connection member 78. Tubular member 71 further includes apertures or perforations 73 disposed along and extending through longitudinal or side wall portions of the member, where the perforations provide fluid flow passages between the valve housing channel and the hollow interior of tubular member 71.

The movable valve member is dimensioned to fit snugly within tubular member 71 while permitting easy (e.g., generally frictionless) movement toward or away from plate 76. Movable valve member 74 further includes a protrusion 75 extending from the surface of the movable valve member that faces plate 76. The protrusion 75 has slightly larger dimensions than the orifice dimension and is suitably aligned with orifice 77 so as to block the orifice and provide a fluid tight seal with the plate when the movable valve member is forced against the plate by the bias of coil spring 72. The protrusion can optionally be constructed of a polymer or any other suitable sealing materials and/or include a gasket or O-ring at the contact point with the plate to provide an effective fluid tight seal for a particular gaseous or liquid fluid when biased against the plate. Alternatively, the protrusion and plate can both be constructed of suitable metal materials (e.g., stainless steel) that are designed to provide an effective fluid tight seal for a particular gaseous or liquid fluid.

The fluid line connection member 80 includes a tubular member 82 that extends within and slightly beyond the female threaded end of the connection member, where the outer diameter of the tubular member is smaller than the inner diameter of member 80 so as to define an annular gap between the tubular member and the internal female threaded wall portions of member 80. The other end of tubular member 82 connects with a fluid channel 86 that leads to or defines a fluid line for a semiconductor manufacturing or other fluid processing system. Tubular member 82 also includes apertures or perforations 83 disposed at least along the tubular wall portions that extend slightly beyond the female threaded end of member 80, where the perforations extend through the wall thickness of the tubular member to permit fluid to pass into the tubular member via the perforations.

Tubular member 82 is further configured to have a suitable length and outer diameter dimensions such that, when connection members 78 and 80 are connected to each other, the tubular member extends within member 78 and through orifice 77 to engage with protrusion 75. As can be seen in FIG. 4B, upon complete connection of the two connection members 78 and 80, the force applied by tubular member 82 to protrusion 75 overcomes the spring bias, which results in movement of movable valve member 74 and protrusion 75 away from orifice 77 and toward the first end of tubular member 71 so as to release the fluid tight seal and open valve 70.

Thus, connection of members 78 and 80 results in an opening of valve 70. This permits fluid stored within the cylinder to flow into the channel of the valve housing, through perforations 73 located near the second end of tubular member 71 (e.g., within a distance from the second end at which valve member 74 has been displaced by member 82), through perforations 83 and into member 82. The fluid continues to flow through tubular member 82 into fluid channel 86 for delivery to a selected process. When connection members 78 and 80 are separated from each other, tubular member 82 is removed from engagement with protrusion 75, and the bias of spring 72 forces valve member 74 back toward plate 76. The spring further forces protrusion 75 against the plate at orifice 77 to form a fluid tight seal, thus closing valve 70. The spring tension of coil spring 72 can be selectively adjusted to prevent opening of the valve by ambient pressure levels that surround the cylinder, thus preventing undesirable backflow of fluids (e.g., air) into the cylinder through valve 70. In addition, the valve is designed to prevent any flow of fluid from the cylinder through valve 70 when fluid line connection member 80 is not attached with valve connection member 78.

As noted above, the valve embodiments of FIGS. 3 and 4 can be implemented for use in either or both of the filling and outlet ports of the valve device of FIG. 2. Alternatively, these valve embodiments can also be used for a valve device that includes a single port. In other words, these valve embodiments facilitate both filling of a cylinder to which the valve device is attached and delivery of fluid from the cylinder to a system fluid line, while preventing backflow of fluids into the cylinder and undesirable leakage of fluid from the cylinder while the valves are closed. Further, the valve embodiments of FIGS. 3 and 4 can be utilized in a valve device that does not include a stop valve (e.g., such as the stop valve depicted in the device of FIG. 2), such that the only valve employed between the cylinder and a fluid flow line attached to the cylinder is the valve of FIG. 3 or FIG. 4.

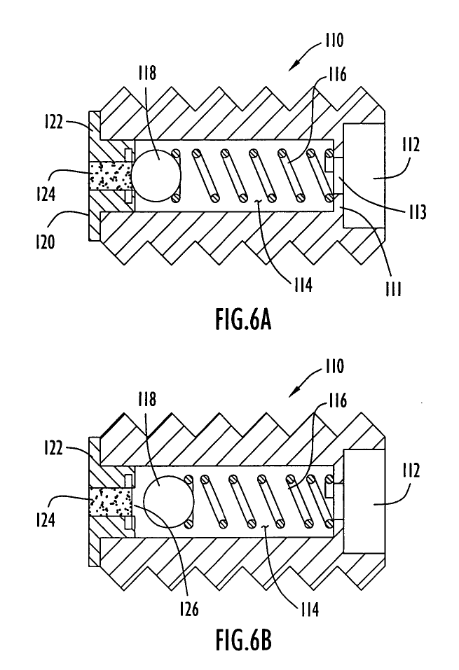

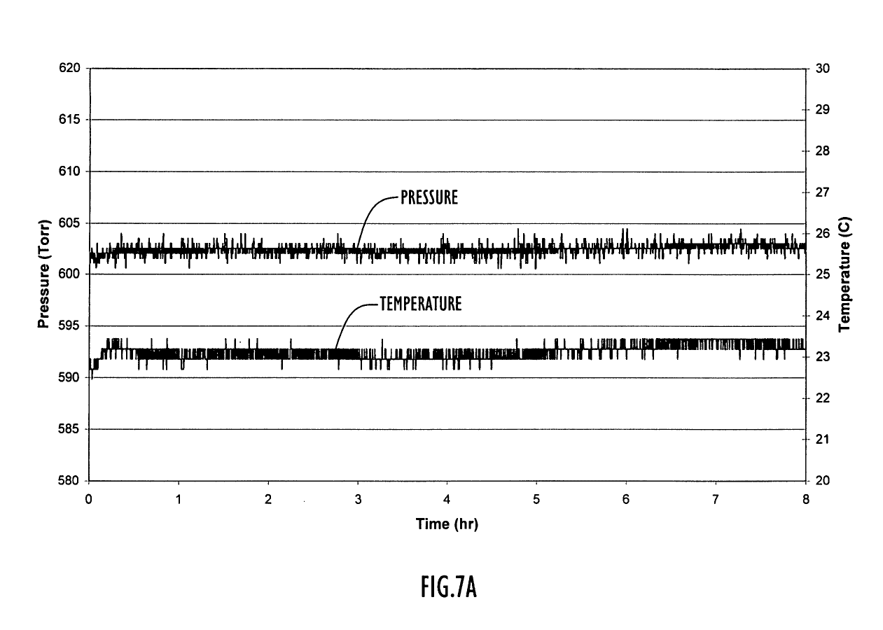

A further embodiment of a valve device is depicted in FIGS. 5 and 6. Referring to FIG. 5, valve device 100 is connected to cylinder 1 via a threaded connection at a first connection port 21 of the device. A main channel 22 extends axially within the main body 101 of the valve device and is in fluid communication with connection port 21 as well as a second port 102 that extends transversely from the main body.

A shut-off or stop valve is defined within the main body 101 by a movable body 26 that is axially movable within the main body to engage with a seat 28 located at an end of channel 22. As in the stop valve embodiment of FIG. 2, channel seat 28 provides a restricted channel passage to facilitate the formation of a fluid tight seal when movable body 26 engages with the seat, and the movable body is connected to a handle 27 that can be manipulated in a conventional (e.g., by rotation of the handle) to effect movement of the body 26 toward or away from seat 28 in order to close or open the stop valve.

The second port 102 extends transversely from channel 22 at the location of the stop valve seat 28 such that, when movable body 26 is displaced or moved away from a sealing engagement with seat 28, the second port is in fluid communication with channel 22 and cylinder 1. Port 102 further includes an open end 104 having an externally (i.e., male) threaded configuration and an internally threaded channel 106 disposed within the second port and which communicates with open end 104. The internally threaded channel 106 of port 102 provides a female threaded connector configuration for a corresponding externally or male threaded valve member 110, which is described in further detail below. The externally or male threaded configuration of open end 104 facilitates a fluid tight connection between the valve device and a corresponding female threaded connector for a fluid flow line. The fluid flow line that connects with port 102 can be a filling line for cylinder 1 or a fluid line for delivering fluid from the cylinder to a process. Thus, port 102 serves as both a filling port for cylinder 1 and an outlet port for delivery of fluid from the cylinder to a desired process or application. However, as noted in further detail below, if port 102 is used to fill cylinder 1, valve member 110 must first be removed from the valve device.

Valve member 110 has a generally cylindrical, plug-like configuration that is preferably configured to substantially fit within threaded channel 106 of port 102 when the valve member is installed within the valve device. Referring to FIGS. 6A and 6B, valve member 110 includes a hollow interior or chamber 114 that extends between open ends of the valve member, where the chamber is suitably dimensioned to receive valve components that operate in a manner described below to open and close the valve member.

A sealing member 122 (e.g., a gasket) is secured within a first open end of member 110 to provide a fluid tight seal at the first open end. The sealing member can be constructed of any suitable materials (e.g., polymer materials such as plastics or rubber materials, metals such as stainless steel, etc.) that serve to provide an effective seal at the first open end of the valve member and depending upon a particular fluid to be processed by the valve device. As can be seen in FIGS. 6A and 6B, the sealing member has a generally T-shaped cross-sectional configuration, with an end portion of the sealing member (i.e., the top of portion of the “T”) secured against the first open end of the valve member. This configuration provides significant surface area contact between the sealing member and portions of the first end of valve member 110 to ensure a fluid tight seal is maintained. A channel 124 extends axially through sealing member 122. Optionally, channel 124 can include a porous filter media or material having a suitable pore size so as to provide filtration of fluids passing through the channel during operation of the valve member.

Other valve components disposed within chamber 114 include a movable member 118 and a biasing member 116 (e.g., a coil spring) that is disposed between the movable member and a second open end of the valve member so as to bias the movable member toward sealing member 122. An annular ledge 111 extends radially inward within the hollow interior of valve member 110 at the second end to secure biasing member 116 within chamber 114. A central orifice 113 is further defined at the ledge 111 so as to ensure a fluid flow path exists between chamber 114 and the second open end of the valve member.

The valve member optionally includes a notch 112 at the second open end that is suitably configured to receive a tool that facilitates threaded attachment of the valve member within internally threaded channel 106 of the filling/outlet port of the valve device. The valve member is oriented during assembly such that the first end of the valve member is first inserted within internally threaded channel 106 of the port, and notch 112 is exposed to allow the tool to engage the second end of the valve member. Thus the first end is the inlet of valve member 110, while the second end is the outlet of the valve member. The notch can have any suitable shape to facilitate engagement with any type of tool (e.g., a screwdriver, wrench, etc.). For example, notch 112 can have a generally hexagonal shape to receive a corresponding hexagonal shaped wrench.

The movable member and biasing member disposed within the chamber of the valve member are suitably dimensioned and configured such that the biasing member forces the movable member against a valve seat disposed on a surface of the sealing member, where the forced engagement of the movable member at the valve seat results in a fluid tight relationship that prevents fluid from flowing in either direction through the sealing member (thus preventing fluid from entering the valve member chamber through its first end). As shown in FIGS. 6A and 6B, movable member 118 has a generally spherical configuration and is biased to engage with sealing member 122 at a recessed surface portion or seat 126 of the sealing member. The recessed surface portion or seat 126 can be formed in any suitable manner at this surface of the sealing member. For example, the seat may be formed by providing a notch in the sealing member. Alternatively, the seat may be formed by securing an O-ring to this surface of the sealing member, where the O-ring is formed of a resilient or other suitable material (e.g., rubber) that provides an effective fluid tight seal when the movable member engages with the seat. The O-ring can be secured to the sealing member in any suitable manner (e.g., by applying the O-ring directly to the outer surface of the sealing member or, alternatively, by securing the O-ring within a portion of the sealing member).

The movable member can be constructed of any suitable materials (e.g., polymers such as polytetrafluoroethylene commercially available under the trademark TEFLON, metals such as stainless steel, etc.) that provide an effective sealing arrangement between the movable member and the sealing member and depending upon a particular fluid that is being processed by the valve device. In addition, while the movable member is shown in FIGS. 6A and 6B as having a spherical configuration, the movable member is not limited to this configuration. Rather, the movable member can have a disk-shaped configuration and/or any other suitable configurations that provide an effective fluid tight seal for a particular application.

In operation, valve device 100 is secured to cylinder 1 and, if necessary, the cylinder can be filled with fluid at port 102 of the device. Valve member 110 is secured within the internally threaded channel 106 of valve device 100 (e.g., via a suitable tool) so as to achieve a suitable fluid tight engagement. The valve member can be secured to the valve device either before the valve device is secured to the cylinder (e.g., in applications where the cylinder has already been filled with fluid) or after the valve device has been secured to the cylinder (e.g., in applications where the valve device is also used to fill the cylinder via port 102). The stop valve is then opened (by moving movable body 26 away from valve seat 28) to facilitate fluid communication between cylinder 1 and port 102.

The biasing or spring tension of biasing member 116 is configured to be greater than the cylinder pressure, such that movable member 118 within valve member 110 maintains a fluid tight seal against sealing member 122 (as shown in FIG. 6A) until such time at which it is desirable to withdraw fluid from the cylinder. A fluid flow line can be connected with open end 104 of the valve member, and a vacuum applied within the fluid line. The vacuum generates a suitable pressure differential across valve member 110 and, in particular, across sealing member 122, such that the fluid pressure within the cylinder is greater than the pressure within the fluid line. This pressure differential reduces the biasing force of biasing member 116 on movable member 118, such that movable member 118 is forced away from sealing member 122 and the valve member is opened (as shown in FIG. 6B). In this configuration, fluid flows from cylinder 1 through channel 22 and into port 102. The fluid further flows through channel 124 of the sealing member (where it is optionally filtered by porous filter media disposed within this channel), and then flows through chamber 114 and around movable member 118 and biasing member 114, through orifice 113 and out of the second open end of the valve member. The vacuum within the flow line further draws the fluid out of valve port 102 and into the flow line to a desired application.

When it is desired to cease delivery of fluid from the cylinder, vacuum is no longer applied within the fluid flow line. Biasing member 116 forces movable member 118 back into sealing engagement with sealing member 122, resulting in closing of the valve member once again (as shown in FIG. 6A). Fluid is prevented from flowing from cylinder 1. In addition, valve member 110 prevents backflow of any fluids (e.g., air) in the surrounding environment or system line that may be at a greater pressure than the cylinder pressure from flowing into the cylinder via valve port 102, since such pressures result in the movable member being biased back into a sealing engagement with the seat so as to close the valve.

The one-way valve member described above and depicted in FIG. 6 is highly effective, particularly in SAGS applications, in preventing backflow of fluids into a cylinder. In addition, the design of the valve member renders the valve member suitable for use in a wide variety of conventional or other types of valve embodiments including, without limitation, the valve ports describe in the valve designs of FIGS. 2 and 5. In addition, as in the other embodiments described above, the valve member of FIG. 6 can be used in valve designs that do not include a stop valve and/or in valve designs where the valve member is the only valve employed to control fluid flow through the valve device. In addition, the valve member design of FIG. 6 can be incorporated in a fixed (i.e., non-removable) configuration within a valve device.

The valve member is easily removable and securable within a valve port, and this securing operation can be achieved without the requirement of disassembling the valve device from a cylinder. In addition, the other valve embodiments described above can also be configured so as to be easily removable from a cylinder valve housing. As with the other valve embodiments described above, the valve member described in FIGS. 6A and 6B can be used with any valve device for storage, shipping and/or use of the fluid within a cylinder.

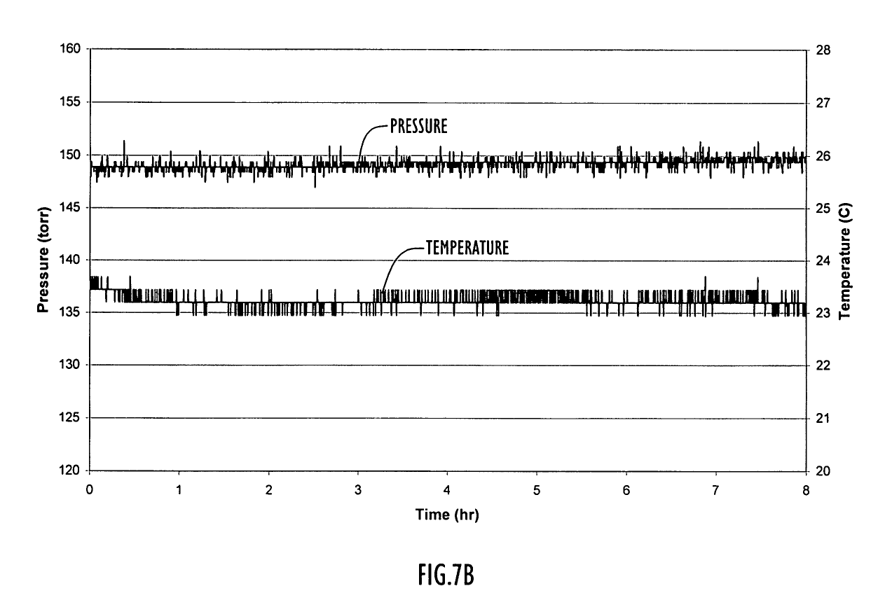

The effectiveness of the valve member described above is demonstrated in the following example. The valve member of FIGS. 6A and 6B was utilized in a cylinder valve device such as the type set forth in FIG. 5. The cylinder was filled with fluid at two different pressures that are below typical atmospheric pressures (i.e., cylinder pressures below about 760 torr or 101.3 kPa) and the stop valve was left open with the valve member installed in an outlet port of the valve device. The graphs depicted in FIGS. 7A and 7B show the pressure and temperature within the cylinder vs. time, where the main stop valve of the valve device was kept in an open position. As can be seen in these graphs, the pressure and temperature within the cylinder remained relatively constant at both pressure levels for an extended period of time (i.e., several hours). Thus, the pressure and temperature data indicates that fluid leakage in the cylinder as well as backflow of air and/or other fluids within the cylinder were effectively prevented by the valve member.

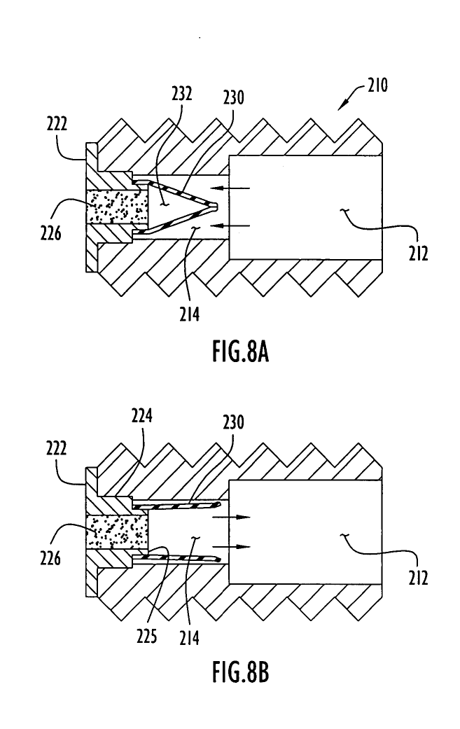

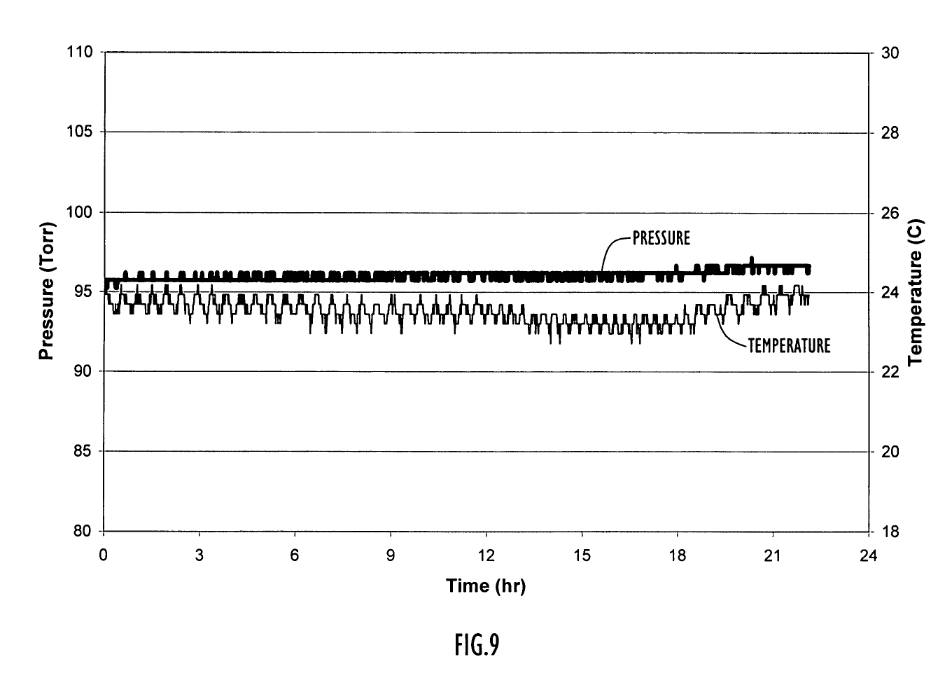

Another embodiment of a plug-like valve member that can be secured within a channel of an outlet port (e.g., port 102 of valve device 100 as depicted in FIG. 5) is depicted in FIGS. 8A and 8B. In particular, valve member 210 has a generally cylindrical, plug-like configuration with external or male threads. The valve member is configured to be partially or substantially secured within a threaded channel of an outlet port of any one or more suitable types of valve devices. For example, the valve member can be secured within threaded channel 106 of port 102 of the valve device of FIG. 5. Alternatively, the valve member can also be designed to be fixed (i.e., non-removably secured) in an outlet port or any other portion of a valve device, as in some of the previous embodiments.

Valve member 210 includes a channel extending axially between inlet and outlet ends of the valve member, where the channel includes a chamber 214 that extends from the inlet end of the valve member a selected distance within the valve member. Chamber 214 is suitably dimensioned to receive valve components that operate in a manner described below to open and close the valve member.

In addition, the axially extending channel includes a notch 212 extending from the outlet end of the valve member to chamber 214, where the notch 212 extends to chamber 214 and is slightly larger in transverse cross-sectional dimension than the portion of chamber 214 that is adjacent the notch. The notch 212 is suitably configured to receive a tool that facilitates threaded attachment of the valve member within the internally threaded channel of the filling/outlet port of the valve device. The valve member is oriented during assembly such that the inlet end of the valve member is first inserted within the internally threaded channel of the port, and notch 212 is exposed to allow the tool to engage the outlet end of the valve member. The notch can have any suitable shape (e.g., hexagonal) to facilitate engagement with any type of tool (e.g., a screwdriver, wrench, etc.).

An insert member 222 is secured within the inlet end of valve member 210 to provide a fluid tight seal at the inlet end. The insert member can be constructed of any suitable materials (e.g., polymer materials such as plastics or rubber materials, metals such as stainless steel, etc.) that serve to provide an effective fluid tight seal at the inlet end of the valve member and depending upon a particular fluid to be processed by the valve device. Insert member 222 has a generally T-shaped cross-sectional configuration, with a first portion 223 of the insert member (i.e., the top of portion of the “T”) being secured against the open inlet end of the valve member. A second portion 224 of the insert member is securely fit within chamber 214 of the valve member and engages in a fluid tight seal with interior wall surface portions of the valve member. The insert member configuration provides significant surface area contact between the sealing member and inlet end portions of valve member 110 to ensure a fluid tight seal is maintained. A third portion 225 of the insert member extends from and has a transverse cross-sectional dimension that is smaller than that of second portion 224. The third portion is suitably designed to engage with a valve sealing member 230 described below.

A passage or channel 226 extends axially through insert member 222. Optionally, channel 226 can include a porous filter media or material having a suitable pore size so as to provide filtration of fluids passing through the channel during operation of the valve member. The channel 226 communicates with chamber 214 so as to permit fluid to flow through the insert member from the inlet of valve member 210 and into the chamber when valve sealing member 230 is in an open position as described below.

Sealing member 230 is constructed of a suitable elastomeric material. Any suitable elastomeric material can be used to form the sealing member that is compatible with the fluid to be processed including, without limitation, materials such as fluorosilicone, fluorocarbon, and ethylene propylene. The sealing member is hollow and includes a channel 232 extending axially through and between an inlet end and an outlet end of member 230. The inlet end of the sealing member is secured around third portion 225 of the insert member to form a fluid tight seal at such engagement. The outlet end of sealing member 230 is formed by flaps or lip portions of the sealing member that contact each other to form a sealing slit at the outlet end. As can be seen from FIG. 8A, the sealing member has a generally conical cross-sectional configuration with the lip portions resembling a “duck bill” with the sealing slit at its outlet end.

When a valve device is secured to a fluid flow line (e.g., in a manner as described above for the valve device of FIG. 5), and valve member 210 is secured within the outlet port of the valve device, sealing member 230 maintains a sealed position as shown in FIG. 8A when a certain pressure differential exists across the valve member. In particular, when the pressure in the fluid line is greater than the fluid pressure within the cylinder to which the valve device is attached (e.g., in SAGS applications), the elastomeric “duck bill” lip portions at the outlet end of member 230 maintain contact with each other in a fluid tight relationship so as to prevent fluid from passing through the slit and into channel 232 (as indicated by the arrows shown in FIG. 8A).

However, when the fluid pressure within the cylinder to which the valve device is attached is greater than the fluid flow line pressure or the pressure downstream from sealing member 230 (e.g., when a vacuum is applied within the fluid flow line to establish a suitable pressure differential across the valve member), the fluid pressure within the cylinder forces the elastomeric “duck bill” lip portions to flex and separate from each other as shown in FIG. 8B. This separation opens valve member 230 to permit fluid to flow from the inlet end of member 230, through passage 226 (where it is optionally filtered) and passage 232, into chamber 214 and out of the valve member and outlet port of the valve device to the fluid flow line (as shown by the arrows in FIG. 8B). When the pressure within the cylinder is again lower than the downstream pressure from the valve member (e.g., when vacuum is no longer applied within the fluid flow line), the “duck bill” lip portions flex back to their original sealing positions in which the lip portions engage with each other, as shown in FIG. 8A, to seal the outlet end of sealing member 230 so as to close valve member 210.

An example showing the effectiveness valve member of FIGS. 8A and 8B is now described with reference to FIG. 9. In particular, the valve member was installed in the outlet port of a valve device similar to that described above and depicted in FIG. 5. The valve device was connected to a cylinder containing a gaseous fluid at a pressure well below typical atmospheric pressures. The stop valve of the valve device was left open to test the valve member. As can be seen from the temperature and pressure data plotted in FIG. 9, the temperature and pressure data remained relatively constant over a period of several hours, with a substantially small leak rate calculated to be about 2.2×10⁻¹² atm/cc/sec. This example demonstrates that the valve member maintains a sufficient fluid tight seal and further prevents backflow of higher pressure fluids (e.g., air) into the cylinder.

Having described novel valve devices and corresponding methods for containing and preventing backflow of fluids, it is believed that other modifications, variations and changes will be suggested to those skilled in the art in view of the teachings set forth herein. It is therefore to be understood that all such variations, modifications and changes are believed to fall within the scope as defined by the appended claims.

1. A valve device for use with a cylinder, the valve device comprising:
a housing including a central passage in fluid communication with a first connection port that connects with a cylinder;
a second connection port including a passage that is in fluid communication with the central passage, the second connection port being configured to connect with a fluid flow line; and
a valve member disposed within the second connection port and including a movable member that engages with a seat to provide a fluid tight seal for the valve member in a closed position, wherein the movable member is configured to be moved away from the seat so as to open the valve member and permit fluid to flow from the central passage of the valve housing around the movable member and through the second connection port while substantially preventing a backflow of fluids from a location external to the valve housing into the central passage.

2. The valve device of claim 1, wherein the movable member moves away from the seat and away from the central passage to open the valve member when the fluid pressure within the vessel to which the valve device is secured is greater than the pressure within a fluid line that is attached to the second connection port and a selected pressure differential is achieved across the movable member.

3. The valve device of claim 2, wherein the selected pressure differential is less than about 760 torr (101.3 kPa).

4. The valve device of claim 2, wherein the selected pressure differential is within a range of about 50 torr (6.67 kPa) to about 300 torr (40 kPa).

5. The valve device of claim 2, further comprising:
a third connection port that connects with a filling device to fill the cylinder to which the valve device is secured; and
a second valve member disposed within the third connection port and including a second movable member that engages with a second seat to provide a fluid tight seal for the second valve member so as to substantially prevent fluid from flowing from the central passage and out of the valve housing through the third connection port, wherein the second movable member is configured to be moved away from the second seat to permit fluid to flow from the filling device to which the third connection member is secured around the second movable member and into the central passage of the valve housing.

6. The valve device of claim 1, wherein the movable member is configured to be moved away from the seat in a direction toward the central passage so as to open the valve member and permit fluid to flow from the central passage of the valve housing around the movable member and through the second connection port.

7. The valve device of claim 6, further comprising:
a connector configured to connect the second connection port with the fluid flow line, the connector including an elongated member that is aligned to extend within the second connection port and force the movable member to move away from the seat so as to open the valve member when the connector is connected with the second connection port.

8. The valve device of claim 7, wherein the elongated member includes at least one perforation disposed along a sidewall portion of the elongated member and that is in fluid communication with a hollow interior of the elongated member, and the hollow interior of the elongated member is in fluid communication with a channel disposed within the connector so as to establish a fluid flow path between the valve device and the fluid flow line when the connector is connected to the second connection port.

9. The valve device of claim 7, wherein the movable member includes a diaphragm that is configured to flex away from the seat in the direction toward the central passage when the elongated member engages with the diaphragm and to flex back into engagement with the seat when the elongated member disengages from the diaphragm.

10. The valve device of claim 7, wherein the valve member further includes a biasing member that forces the movable member toward the seat, and the elongated member overcomes the force of the biasing member to move the movable member away from the seat when the connector is connected with the second connection port.

11. The valve device of claim 1, wherein the valve member comprises a hollow plug that includes the movable member and the seat disposed within a chamber of the plug, and the plug is removably securable within the second connection port.

12. The valve device of claim 11, wherein the plug further includes a biasing member disposed within the chamber that biases the movable member against the seat.

13. The valve device of claim 12, further comprising:
a sealing member disposed at a first end of the plug, wherein the sealing member includes the seat and further includes a channel that extends through the sealing member and is aligned with the seat and is in fluid communication with the chamber, and the plug includes a second end with an opening that facilitates a fluid flow path between the first and second ends of the chamber and through the plug when the movable member is moved away from the seat.

14. The valve device of claim 13, wherein the sealing member channel includes a porous filter media to filter fluid that passes through the sealing member channel.

15. A valve member comprising:
a hollow plug including a chamber, a first end and a second end, wherein the first and second ends include openings;
a movable member disposed within the chamber; and
a biasing member that forces the movable member toward the first end of the plug so as to engage with a seat defined at the first end;
wherein the movable member and seat engage to form a fluid tight seal to prevent fluids from entering the chamber via the first end opening, and the movable member is movable away from the seat to permit access of fluids through the chamber via the first end opening when the force applied by the biasing member is overcome by an opposing force applied to the movable member.

16. The valve member of claim 15, wherein an outer surface portion of the plug is threaded to facilitate insertion and securing of the plug within an internally threaded channel of a valve device.

17. The valve member of claim 15, further comprising:
a sealing member at least partially secured within the opening at the first end of the plug, wherein the sealing member includes the seat and further includes a channel that extends through the sealing member and is aligned with the seat and is in fluid communication with the chamber.

18. The valve member of claim 17, wherein the sealing member channel includes a porous filter media to filter fluid that passes through the sealing member channel.

19. The valve member of claim 15, wherein the movable member is spherical in shape.

20. A method of controlling fluid flow within a cylinder with a valve device secured to the cylinder, the method comprising:
securing a valve device to an outlet of the cylinder, wherein the valve device includes a valve housing with an outlet port to deliver fluid from the cylinder to a fluid flow line; and
providing a valve member in the outlet port of the valve device, wherein the valve member includes a passage that is in fluid communication with a central passage of the valve housing, and a movable member that engages with a seat to provide a fluid tight seal for the valve member in a closed position, the movable member being configured to be moved away from the seat so as to open the valve member and permit fluid to flow from the central passage of the valve housing around the movable member and through the outlet port while substantially preventing a backflow of fluids from a location external to the valve housing into the central passage.

21. The method of claim 20, further comprising:
connecting the fluid flow line to the outlet port; and
establishing a selected pressure differential across the movable member of the valve member such that the pressure within the cylinder is greater than the pressure within the fluid flow line;
wherein, upon establishing the selected pressure differential across the movable member, the movable member moves away from the seat and away from the central passage to open the valve member and permit fluid to flow from the cylinder to the fluid flow line.

22. The method of claim 21, wherein the selected pressure differential is less than about 760 torr (101.3 kPa).

23. The method of claim 21, wherein the selected pressure differential is within a range of about 50 torr (6.67 kPa) to about 300 torr (40 kPa).

24. The method of claim 21, wherein the valve housing further includes a filling port, and the method further comprises:
securing the filling port to a fluid supply source;
providing a second valve member in the filling port, wherein the second valve member includes a passage that is in fluid communication with a central passage of the valve housing, and a second movable member that engages with a second seat to provide a fluid tight seal for the second valve member in a closed position, the second movable member being configured to be moved away from the second seat to permit fluid to flow from the supply source around the second movable member and into the central passage of the valve housing for delivery into the cylinder.

25. The method of claim 21, further comprising:
connecting the fluid flow line to the outlet port by securing a connector of the fluid flow line with the outlet port; and
applying a force to the movable member to move the movable member away from the seat in a direction toward the central passage so as to open the valve member and permit fluid to flow from the central passage of the valve housing around the movable member and through the outlet port and into the fluid flow line.

26. The method of claim 25, wherein the force is applied to the movable member by an elongated member of the connector of the fluid flow line that engages with the movable member when the connector is secured to the outlet port.

27. The method of 26, wherein the elongated member includes a hollow interior that serves as part of a fluid flow path between the cylinder and the fluid flow line.

28. The method of claim 21, wherein the valve member comprises a hollow plug that includes the movable member and the seat disposed within a chamber of the plug, and the plug is removably secured within the outlet port.

29. The method of claim 28, wherein the movable member is forced against the seat within the plug chamber by a biasing member also disposed within the plug chamber.

30. The method of claim 29, wherein the seat is defined in a sealing member disposed at an end of the plug, the sealing member includes a channel extending through the sealing member that communicates with the plug chamber, and the method further comprises:
providing a filter media within the channel of the sealing member to filter fluid passing from the cylinder to the fluid flow line.

31. The method of claim 21, wherein the fluid that flows from the cylinder to the fluid flow line comprises at least one of a germane, a silane, a polysilane, a silyl-germane, a silylamine, an organometallic metal compound, a fluorocarbon compound, boron trifluoride, boron trichloride, and tungsten hexafluoride.
